(19) United States
(12) Patent Application Publication
(10) Pub. No.: US 2025/0340013 A1
(43) Pub. Date: Nov. 6, 2025

(54) NEAR-FIELD MICROWAVE 3D PRINTING OF FUNCTIONAL DEVICES

(71) Applicants: John S HO, Singapore (SG); Yang XIN, Singapore (SG); UNIVERSITY OF UTAH RESEARCH FOUNDATION, Salt Lake City, UT (US)

(72) Inventors: Yong Lin KONG, Salt Lake City, UT (US); Samuel HALES; John S HO, Singapore (SG); Yang XIN, Singapore (SG)

(21) Appl. No.: 18/862,392

(22) PCT Filed: May 4, 2023
(86) PCT No.: PCT/US2023/021054

§ 371 Date: Nov. 1, 2024

Related U.S. Application Data
(60) Provisional application No. 63/339,263, filed on May 6, 2022.

(51) Int. Cl. B29C 64/209; B29C 35/08; B29C 64/118; B33Y 30/00; B33Y 40/00

(52) U.S. Cl. CPC B29C 64/209; B29C 35/0805; B29C 64/118; B33Y 30/00; B33Y 40/00; B29C 2035/0855

(57) ABSTRACT

A near-field microwave (NEM) three-dimensional (3D) printing device comprises a metamaterial-inspired near-field electromagnetic structure (Meta-NFS) configured to be placed adjacent to a nozzle of an additive printing device. The Meta-NFS comprises a tapered electrically conductive structure. A first tip and a second tip of the tapered electrically conductive structure forming a gap.

### CROSS-REFERENCE TO RELATED APPLICATIONS

This application claims the benefit of and priority to U.S. Provisional Patent Application Ser. No. 63/339,263 filed on 6 May 2022 and entitled “Near-Field Microwave 3D Printing of Functional Devices,” which application is expressly incorporated herein by reference in its entirety.

### STATEMENT REGARDING FEDERALLY SPONSORED RESEARCH

This invention was made with government support under Grant No. R21 EB029563 awarded by the National Institutes of Health and Grant No. 1830958 awarded by the National Science Foundation. The government has certain rights in the invention.

### BACKGROUND

Additive manufacturing, such as 3D printing, provides a highly flexible means for creating custom objects on demand. These objects have included things as small as tiny gears to as large as entire buildings. Additive manufacturing generally creates relatively little waste while allowing a truly custom object to be created. While additive manufacturing provides several benefits, there are also many accompanying challenges in the field relating to the ability to utilize unique materials in additive manufacturing.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include a near-field microwave (NFM) three-dimensional (3D) printing device. The NFM 3D printing device comprises a metamaterial-inspired near-field electromagnetic structure (Meta-NFS) configured to be placed adjacent to a nozzle of an additive printing device. The Meta-NFS may comprise a tapered electrically conductive structure. A first tip and a second tip of the tapered electrically conductive structure forming a gap.

Disclosed embodiments also include a method for three-dimensional (3D) printing with a near-field microwave device. The method comprises positioning a Meta-NFS adjacent to a nozzle of an additive printing device. The Meta-NFS may comprise a tapered electrically conductive structure, and a first tip and a second tip of the tapered electrically conductive structure forming a gap. The method further comprises generating a microwave signal within the Meta-NFS.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings described below.

FIG. 1 illustrates a chart showing material interactions with microwaves.

FIG. 2 illustrates an embodiment of 3D printing device with a Meta-NFS.

FIG. 3A illustrates various embodiments of tapered Meta-NFSs.

FIG. 3B depicts an embodiment of a Meta-NFSs 220 with accompanying design considerations.

FIG. 4 illustrates a flow chart of a method of using a of 3D printing device with a Meta-NFS.

### DETAILED DESCRIPTION

Disclosed embodiments include a highly focused metamaterial-inspired near-field electromagnetic structure (Meta-NFS) that can enable multiscale process-structure-property control when synergistically integrated with extrusion-based 3D printing. Disclosed embodiments comprise a new class of 3D printing with unprecedented ability to modulate printed material properties on a broad range of temperature-sensitive substrates and create complex 3D heterogeneous multi-material and multifunctional constructs.

The synergistic integration of nanomaterials with 3D printing (a.k.a. additive manufacturing) can enable the creation of architecture and devices with an unprecedented level of functional integration. For example, a multiscale 3D printing approach can seamlessly interweave nanomaterials with diverse classes of materials to impart, program, or modulate a wide range of functional properties in an otherwise passive 3D printed object. Nevertheless, in conventional systems, it remains challenging to pattern, assemble and sinter nano-scale materials with a primarily micron-scale 3D printing process. For conventional systems, these challenges fundamentally constrain the potential functionalities, performance, and material compatibility of the highly versatile multiscale 3D printing process.

Disclosed embodiments include a near-field microwave 3D printing (NFP) process. In at least one embodiment, the integration of highly focused near-field microwaves (300 MHz-300 GHz) can achieve volumetric and selective heating of micro-extruded functional nanomaterials. In particular, disclosed embodiments include the use of highly focused near-field microwave energy to achieve rapid, uniform, and selective volumetric annealing of extruded materials during a microextrusion-based (a.k.a. direct ink writing, DIW) additive manufacturing process.

In at least one embodiment, microwave radiation is focused using Meta-NFSs that consist of tapered transmission lines. The fabricated Meta-NFS can focus microwave energy to subwavelength dimensions (<1 mm), which is needed to achieve the spatial resolution (^{˜}1-10 μm) for three-dimensional printing.

The ability to selectively heat 3D printed nanomaterials in situ establishes a fundamentally new approach to precisely integrate electronics and devices into a 3D, temperature-sensitive, and multi-material construct. Disclosed embodiments enable remote fabrication of active electronics and functional devices. As shown by the recent pandemic, traditional manufacturing of electronics and medical devices is susceptible to factory/logistic shutdowns, extreme demand, natural events, or human-caused disruptions. In contrast to conventional manufacturing, the proposed digital-based approach is more resilient to disruption due to supply chain or factory shutdowns.

Additionally, NFP improves the performance and capabilities of 3D printed electronics, which improves cost-efficiency in comparison to conventional mass-production approaches. In contrast to mass production, printed electronics can promote sustainable production of electronics by reducing electronics waste that is increasingly prevalent in global development.

The integration of nanomaterials with 3D printing can enable the creation of architectures and devices with an unprecedented level of functional integration. Achieving multiscale integration of nanomaterials is challenging as it requires the ability to pattern, assemble, and sinter printed nanomaterials in a primarily micron-scale 3D printing process. For example, in microextrusion printing of silver nanoparticles, a heat treatment process is needed to remove organics and additive residues (e.g., stabilizer, reductant, etc.) as well as to achieve grain growth and densification needed to reach its target property. Due to the lack of ability to selectively heat the printed materials, a significant subset of conventional 3D printing approaches require ‘bulk’ thermal post-processing that constrains the otherwise versatile multiscale 3D printing approach to high-temperature resistance substrates and materials.

Disclosed embodiments provide the ability to leverage the versatility of multiscale 3D printing to incorporate functionalities into soft, temperature-sensitive materials (e.g., silicone, hydrogel). Such a feature is highly desired, particularly in the creation of personalized biomedical devices and electronics that can address unmet clinical needs. The ability to achieve in situ heat treatment in microextrusion-based printing (a.k.a. direct ink writing, DIW) has been previously explored using laser-assisted sintering. Nevertheless, the penetration depth of photonic laser is in the order of nanometer and cannot be transmitted through optically opaque materials, including many polymers and organic matter. It relies predominantly on indirect heat conduction from this penetrated skin depth to anneal the entire print material (typically in the length-scale of 1-100 μm). This constrains not only the uniformity of the heating and the throughput but 5 also its ability to selectively anneal target materials in multi-material, temperature-sensitive constructs.

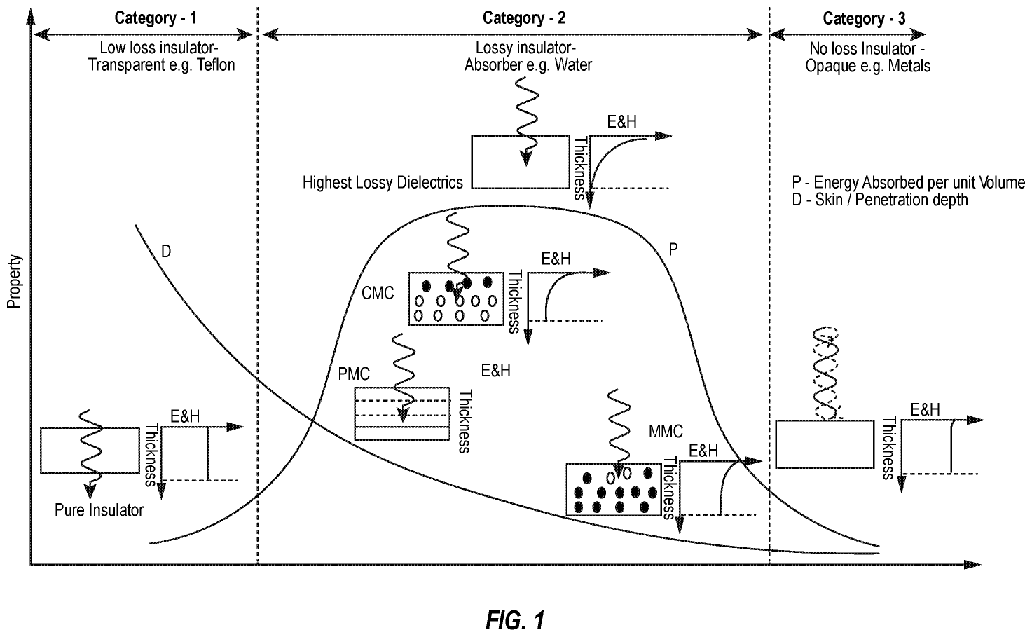

Disclosed embodiments utilize in situ heating with microwave energy. In contrast to traditional heating and welding that requires conductive heat transfer from an external energy gradient, microwave energy can penetrate deeply into a material (within skin depth) and generate heat through dielectric heating. This enables rapid volumetric heating with low input power requirements. Further, the rapid heating of microwave energy is highly selective towards electrically conductive particles and dielectric materials. While methods such as laser heating can selectively heat target materials on temperature-sensitive, optically transparent substrates (including some polymers), microwave heating can selectively heat printed materials on or inside temperature-sensitive, optically opaque materials (including polymers, paper, and organic matter). As described in FIG. 1, microwave energy interaction (energy absorption and skin depth) with materials depends on material properties such as dielectric loss factor and electrical conductivity, as opposed to optical transmission. This selectivity is desirable in the fabrication of a 3D multimaterial construct that incorporates a variety of temperature-sensitive materials.

Turning now to the figures, FIG. 1 illustrates a chart showing material interactions with microwaves. As shown in FIG. 1, there are four classes of microwave interactions. Transparent microwave interactions comprise low loss insulators that allow microwave transmission without absorption. Absorber microwave interactions comprise high loss insulators that readily absorb microwaves. Opaque microwave interactions comprise materials that reflect microwaves with negligible energy absorption. Mixed microwave interactions comprise multiphase materials or composites that consist of materials with different absorption properties.

Electrically conductive particles, including metal and carbon-based particles, are an especially effective class of microwave absorbers. For example, bulk metals are known to be typically “opaque” as they reflect the majority of microwave energy (skin depth ^{˜}1 μm), but metal particles (<^{˜}1 μm diameter) have been demonstrated experimentally to be heated significantly with microwaves. Unlike microwave-absorbing dielectric materials, which primarily experience only dielectric heating, electrically conductive particles can experience both dielectric and magnetic heating upon microwave irradiation, as well as other heating effects (such as plasma formation and magnetically induced eddy currents). This significant heating effect enables metal particle-based inks to be sintered on a range of substrates that have lower microwave absorption, including polymers, paper, and organic matter.

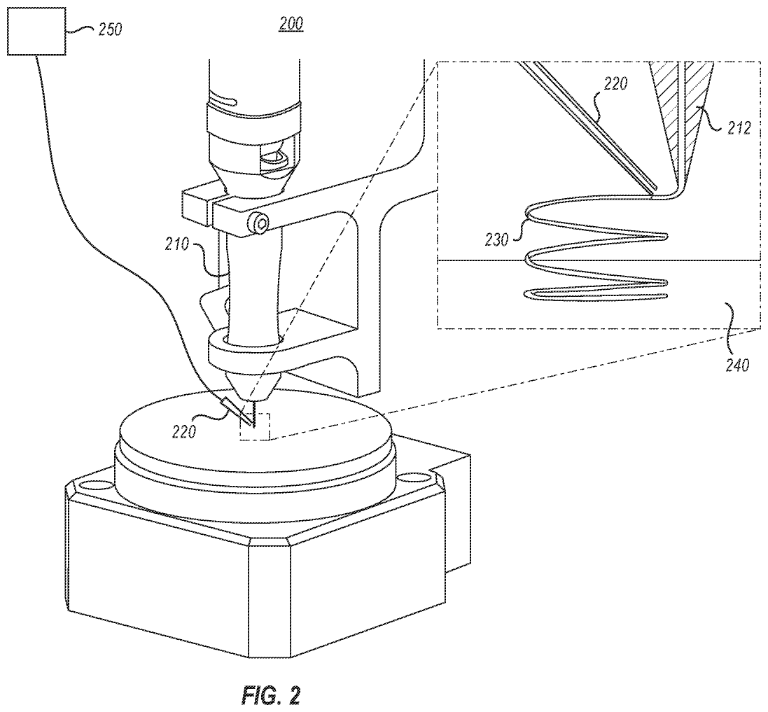

FIG. 2 illustrates an embodiment of 3D printing device 200 with a Meta-NFS 220. As depicted, the Meta-NFS 220 is configured to be placed adjacent to a nozzle 212 of an additive printing device 200. The Meta-NFS 220 comprises a tapered electrically conductive structure. As depicted, the Meta-NFS 220 comprises a first tip and a second tip of the tapered electrically conductive structure forming a gap.

Disclosed embodiments utilize NFM heating by integrating a Meta-NFS 220 based on tapered transmission lines with a microextrusion-based 3D printer. Meta-NFSs 220 can focus electromagnetic fields to points smaller than the wavelength of the radiation used. Meta-NFSs 220 fabricated using tapered transmission lines can focus radiation to points as small as nm-scale, dependent on the gap distance between the tips of the tapered transmission lines.

The depicted 3D printing device 200 comprises a microextrusion-based 3D printer 210. The 3D printing device 200 also comprises a microwave driver circuit 250 connected to a tapered Meta-NFS 220. The microextrusion-based 3D printer 210 comprises a printer nozzle 212 that is extruding a filament 230 onto a substrate 240. During the extrusion, the Meta-NFS 220 can emit microwaves at selected frequencies, amplitudes, pulse widths, pulse rates, and other signal characteristics. In at least one embodiment, the particular signal characteristics are generated by the microwave driver circuit 250 based upon information in a look-up table that describes one or more ideal parameters for a given nanomaterial ink. Using this information, the microwave driver circuit 250 can generate a microwave signal that is optimized to anneal the target material, to program its microstructure and properties.

NFM can induce the heating of materials through dielectric and ohmic heating mechanisms. For a non-magnetic material with complex dielectric permittivity E and conductivity σ, the generated power density (Q_{d}) within the materials is given by Q_{d}=(σ+ωε″) E² where ω is the frequency, ε″ is the imaginary part of the dielectric permittivity, σ is the conductivity of the materials and E is the electric field strength. The term associated with σ describes ohmic heating arising from electronic or ionic conduction, while the ε″ term represents dielectric heating due to molecular dipole relaxation mechanisms.

NFM can generate near-field radiation that is predominantly electric in nature where the penetration of the field is limited by the skin effect, which is characterized by the skin depth

$$D = \sqrt{\frac{2}{{ωσμ}_{0}}}$$

where μ₀ is the permeability of free space. For non-electrically conductive materials, the heating uniformity is limited only by the uniformity of the electric field generated by the Meta-NFS. Notably, as the heating occurs in the near-field, the penetration depth is not limited by wave absorption in the material or reflection at the material surface. For conductive materials, microwave heating results in a skin depth in ^{˜}μm scale that is tunable by adjusting the frequency.

In principle, NFM can also enable selective heating of materials not possible through light-based modalities. As ohmic heating in metals far exceeds dielectric heating in non-conductive materials (σ/ωε″>>10⁶ at 1 GHz), NFM may be able to selectively heat metallic materials embedded completely within non-transparent dielectric materials. Accordingly, the integration of NFM and microextrusion-based multiscale 3D printing can impart rapid and highly selective volumetric heating to nanomaterials in situ during the printing process.

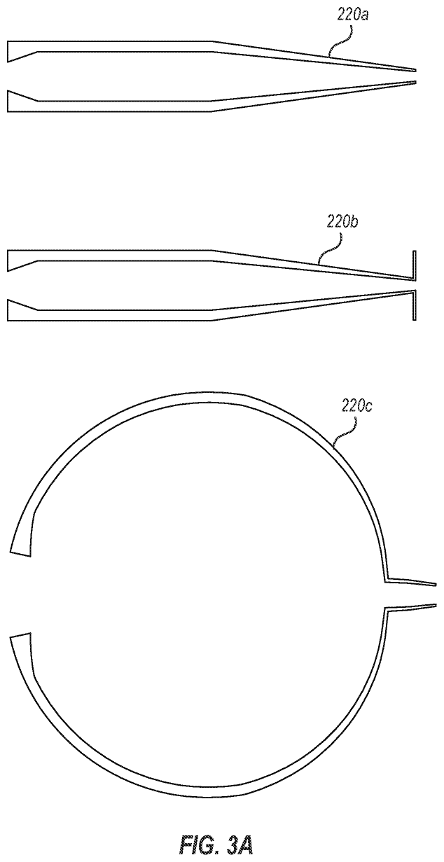

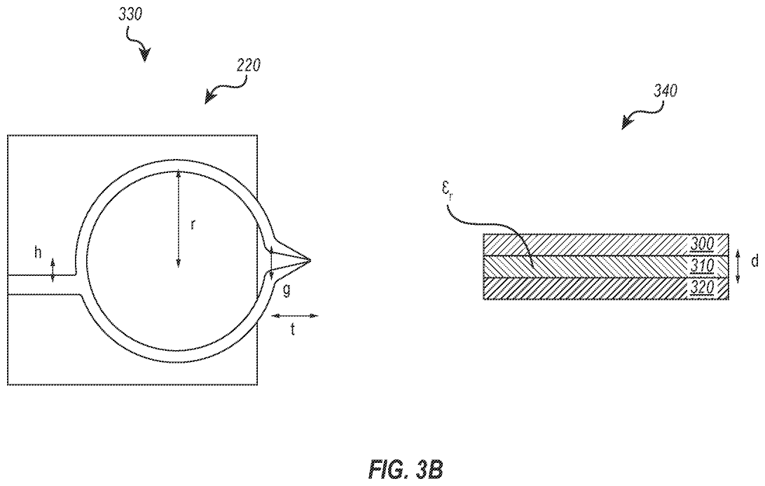

Disclosed embodiments comprise specific antenna geometries, such as tapered transmission lines, that can be designed to focus microwave energy and preferentially heat printed nanomaterials. FIG. 3A depicts various embodiment of exemplary Meta-NFSs 220a, 220b, 220c (referred to collectively as “Meta-NFSs 220”). As depicted, a Meta-NFS 220 comprises a tapered portion at the tip. As used herein, the tapered electrically conductive structure may appear at any point on the Meta-NFSs 220. In at least one embodiment, the tapered portion is positioned at the tip of the Meta-NFSs 220. For example, Meta-NFS 220b comprises portions that flare out perpendicularly from the gap. Nevertheless, the first tip and the second tip of the tapered electrically conductive structure forming a gap. The sub-millimeter spot size of the Meta-NFSs 220 enables high-resolution heating of 3D printed target materials.

FIG. 3B depicts an embodiment of a Meta-NFS 220 with accompanying design considerations. View 330 is a top down view of the Meta-NFS 220 and view 340 is a cross-sectional view of the Meta-NFS 220. As depicted, the Meta-NFS 220 comprises a tungsten layer 300, a low-loss substrate layer 310, and a copper ground plate 320.

A potential design consideration when designing a Meta-NFS 220 is to direct the energy to the tip of the structure (in this embodiment a taper) with minimal reflection at the input port. To accomplish this, a design can create a resonance and further tune the input impedance of the structure such that it matches that of the input port at the operating frequency (f).

The values of r and ∈ᵣ relative to the wavelength λ=c/f (c is the speed of light) enables the Meta-NFS 220 to be resonant. Specifically, a resonance occurs approximately when πr/\sqrt{∈ᵣ}=nλ where n=1, 2, 3, . . . . The resonant frequency can be shifted lower by decreasing d due to the increasing capacitance between the two metal layers. h can be used to tune the input impedance of the Meta-NFS 220. Decreasing g also shifts the resonant frequency lower due to the increased capacitance of the gap. The taper t can be used to further tune the resonant frequency and also control the gap to the target ink. The quality factor of the resonance may depend on the resistance of the Meta-NFS 220 and the loss of the substrate. Generally, greater substrate loss decreases the quality factor and thicker metals (e.g., tungsten and copper) decreases the resistance and hence increases the quality factor.

A Meta-NFS 220 with tapered transmission lines can concentrate microwave energy at the tip of the Meta-NFS. Preliminary simulation and experimental data using a tapered transmission line design has demonstrated the feasibility to achieve sub-millimeter spatial resolution (<1 mm) at a working distance compatible with microextrusion-based 3D printing.

In at least one embodiment, a tapered Meta-NFS 220 is fabricated with a higher temperature resistance using tungsten metal (^{˜}10× melting point of standard copper conductor). Further, in at least one embodiment, the stiffness (Young's modulus of ˜411 GPa) of the tungsten Meta-NFS allows the removal of the underlying polymeric substrate to create a free-standing Meta-NFS. This configuration can eliminate heat loss due to dielectric heating of the polymer substrate as well as challenges associated with Meta-NFS 220 positioning during NFP due to thermal expansion of the polymeric substrate. In at least one embodiment, the Meta-NFS 220 may comprise a 200 μm gap that can achieve tunable microwave power from 0.1 W-50 W. In additional or alternative embodiments, the Meta-NFS 220 may comprise a gap of 50 μm-500 μm. In at least one embodiment, the gap between the first tip and the second tip of the Meta-NFS 220 comprises a distance of between one-tenth of a wavelength and one-fiftieth of a wavelength of the microwave signal generated by the microwave driver circuit 250. In various embodiments, a Meta-NFS 220 with a particular gap size may be selected based upon the printing materials, desired spot size and corresponding printing throughput.

The Meta-NFS can be integrated within an extrusion-based multimaterial 3D printing system. The microextrusion can be controlled with multiple high-precision digital pressure control systems. The Meta-NFS may be attached to an articulating robotic arm that is configured to configured to move and position the Meta-NF. The system may be further integrated with IR cameras to characterize the heating profile at μm-scale resolution.

Due to the inherent selectivity of microwaves, the material composition of the printed ink impacts the sintering process. For instance, the inverted volumetric heating causes swelling as water is vaporized from the core of a printed filament. Disclosed embodiment can enable rapid sintering of the printed nanomaterials, allowing increased stability of high aspect ratio and free-spanning structure as the printed filament is fixed immediately.

Disclosed embodiments provide the ability to fine-tune electrical conductivity by controlling the degree of sintering using the NFP heating parameters (e.g., power, pulse). NPF can enable in situ programming during printing, unlike conventional multi-material printing that requires individual printheads to tailor its properties. This is attractive in three aspects: (i) the properties achievable are not limited to be a discrete value (e.g., from multiple assembly/printing of discrete device) but can be of a continuous gradient. (ii) The printed materials are seamlessly connected, which eliminates the material integration challenges typically associated with integrating multiple materials using multiple nozzles. (iii) A significantly higher throughput can be achieved, as the ability to modulate the properties without changing the printhead continuously removes the bottleneck of multimaterial printing (e.g., switching printhead, parameter, recalibrations).

In at least one embodiment, the ability to penetrate deeply towards the target material without damaging/altering properties of encapsulation materials can enable a highly scalable approach to generate insulated/encapsulated materials which are highly valuable for multi-material printing (e.g., printing directly into temperature-sensitive materials without disintegration).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

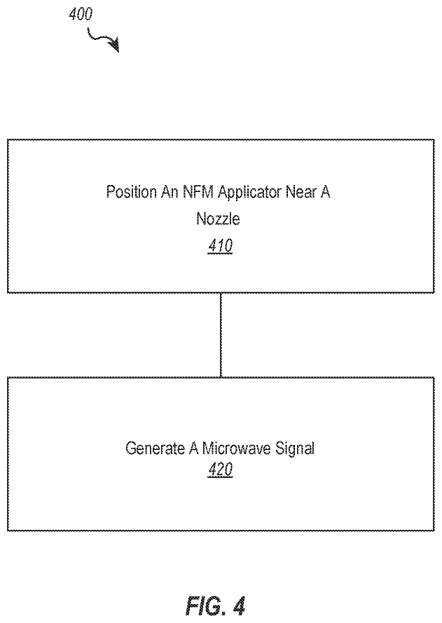

FIG. 4 illustrates a flow chart of a method 400 of using a of 3D printing device with a Meta-NFS 220. Method 400 comprises an act 410 of positioning a Meta-NFS 220 near a nozzle 212. Act 410 comprises positioning a Meta-NFS 220 adjacent to a nozzle 212 of an additive printing device 200. The Meta-NFS 220 comprises a tapered electrically conductive structure. Additionally, a first tip and a second tip of the tapered electrically conductive structure forming a gap. For example, as depicted and described with respect to FIG. 2 and FIG. 3A, an additive printing device 200 may comprise a Meta-NFS 220. Further, several different configurations of Meta-NFSs 220(a-c) may be used. In each of the embodiments depicted in FIG. 3A, a first tip and a second tip of the tapered electrically conductive structure form a gap.

Additionally, method 400 includes an act 420 of generating a microwave signal. Act 420 comprises generating a microwave signal within the Meta-NFS 220. For example, as depicted and described with respect to FIG. 2, the Meta-NFS 220 can emit a microwave signal into a filament 230 causing particles within the filament to anneal.

The various steps and devices described herein may utilize computing systems. For example, as described above, the microwave driver circuit 250 may access a software program that includes a database, or look-up table, that describes various signal properties for various different substrates, nanoparticles, and filaments. As such, the microwave driver circuit 250 is able to use software to identify the ideal microwave signal for a given 3D print job. Further, in at least one embodiment, the software may be configured to cause the microwave driver circuit 250 to vary the microwave signal during the 3D printing process. For example, the software may identify one or more microwave sensitive components on a substrate. When printing near those components, the software may cause the microwave driver circuit 250 to reduce the power level of the microwave signal. Further, the software can also adjust the microextrusion-based 3D printer 210 to slow down or speed up extrusion speed based upon data in the look-up table.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A near-field microwave three-dimensional (3D) printing device, comprising:
a metamaterial-inspired near-field electromagnetic structure (Meta-NFS) configured to be placed adjacent to a nozzle of an additive printing device;
the Meta-NFS comprising a tapered electrically conductive structure; and
a first tip and a second tip of the tapered electrically conductive structure forming a gap.

2. The near-field microwave 3D printing device of claim 1, wherein the additive printing device comprises a microextrusion-based 3D printer.

3. The near-field microwave 3D printing device of claim 1, wherein the gap between the first tip and the second tip comprises a distance of less than 500 microns.

4. The near-field microwave 3D printing device of claim 1, wherein the gap between the first tip and the second tip comprises a distance of between a one-tenth of a wavelength and one-fiftieth of a wavelength.

5. The near-field microwave 3D printing device of claim 1, wherein the Meta-NFS is attached to a robotic arm, the robotic arm configured to move and position the Meta-NFS.

6. The near-field microwave 3D printing device of claim 1, further comprising a microwave driver circuit configured to provide a signal to the Meta-NFS.

7. The near-field microwave 3D printing device of claim 6, wherein the microwave driver circuit is configured to provide a selected frequency to the Meta-NFS.

8. The near-field microwave 3D printing device of claim 6, wherein the microwave driver circuit is configured to provide a selected power level to the Meta-NFS.

9. The near-field microwave 3D printing device of claim 6, wherein the microwave driver circuit is configured to provide a selected pulse rate to the Meta-NFS.

10. The near-field microwave 3D printing device of claim 1, wherein the tapered electrically conductive structure comprises tungsten.

11. A method for three-dimensional (3D) printing with a near-field microwave device, comprising:
positioning a metamaterial-inspired near-field electromagnetic structure (Meta-NFS) adjacent to a nozzle of an additive printing device, wherein:
the Meta-NFS comprising a tapered electrically conductive structure, and
a first tip and a second tip of the tapered electrically conductive structure forming a gap; and
generating a microwave signal within the Meta-NFS.

12. The method of claim 11, wherein the additive printing device comprises a microextrusion-based 3D printer.

13. The method of claim 11, wherein the gap between the first tip and the second tip comprises a distance of less than 500 microns.

14. The method of claim 11, wherein the gap between the first tip and the second tip comprises a distance of between one-tenth of a wavelength and one-fiftieth of a wavelength.

15. The method of claim 11, wherein the Meta-NFS is attached to a robotic arm, the robotic arm configured to move and position the Meta-NFS.

16. The method of claim 11, further comprising a microwave driver circuit configured to provide a signal to the Meta-NFS.

17. The method of claim 16, wherein the microwave driver circuit is configured to provide a selected frequency to the Meta-NFS.

18. The method of claim 16, wherein the microwave driver circuit is configured to provide a selected power level to the Meta-NFS.

19. The method of claim 16, wherein the microwave driver circuit is configured to provide a selected pulse rate to the Meta-NFS.

20. The method of claim 11, wherein the tapered electrically conductive structure comprises tungsten.
